(19) United States
(12) Patent Application Publication
(10) Pub. No.: US 2018/0278910 A1
(43) Pub. Date: Sep. 27, 2018

(54) CORRECTION OF MULTIPATH INTERFERENCE IN TIME OF FLIGHT CAMERA DEPTH IMAGING MEASUREMENTS

(71) Applicant: MICROSOFT TECHNOLOGY LICENSING, LLC, Redmond, WA (US)

(72) Inventors: Michael John Schoenberg, Seattle, WA (US); Kamal Ramachandran Kuzhinjedathu, Redmond, WA (US); Mikhail Smirnov, Bellevue, WA (US); Christopher Stephen Messer, Redmond, WA (US); Michael Jason Gourlay, Seattle, WA (US)

(73) Assignee: MICROSOFT TECHNOLOGY LICENSING, LLC, Redmond, WA (US)

(21) Appl. No.: 15/466,361

(22) Filed: Mar. 22, 2017

(51) Int. Cl. H04N 13/02

(52) U.S. Cl. CPC H04N 13/025; H04N 13/0207

(57) ABSTRACT

A system for determining distances to features in a scene is disclosed. The system includes, among other features, a target portion identifier module, a target surface generator, a reflector selection module, a light transport simulation module, a depth measurement correction generation module, and a distance calculation module. The target portion identifier module is configured to identify a plurality of target portions of the scene. The target surface generator is configured to simulate a plurality of target surfaces. The reflector selection module is configured to select a first plurality of reflector surfaces from the plurality of target surfaces and a second plurality of reflector surfaces from the first plurality of reflector surfaces. The light transport simulation module is configured to, for each target surface included in the target surfaces, simulate a multipath reflection of light emitted by the camera, reflected by the reflector surface to the target surface, and reflected by the target surface to the camera, to generate a simulated multipath response for the target surface. The depth measurement correction generation module is configured to generate a depth measurement correction for each target surface based on the simulated multipath response. The distance calculation module is configured to determine distances for the pixels based on the depth measurement corrections.

### BACKGROUND

Time of flight imaging is a type of depth sensing technology used in many computer vision applications such as object tracking and recognition, human activity analysis, hand gesture analysis, and indoor 3D mapping, amongst others. A time of flight camera system includes one or more light sources which emit rays of light into a scene, and a light sensor such as a camera. The time of flight system works by computing the time it takes a ray of emitted light to bounce off a surface and return to a camera at the system. This gives a measurement of the depth of the surface from the camera. Time of flight systems are generally able to achieve reasonable accuracy and operate in low illumination settings where they use light in the infrared spectrum.

However, time of flight camera systems suffer from multipath interference. Where the emitted rays of light are sent out for each pixel, and since light can reflect off surfaces in myriad ways, a particular pixel may receive photons originally sent out for other pixels as well. This results in corrupted sensor measurements. These corruptions do not look like ordinary noise, and can be quite large, resulting in highly inaccurate depth estimates. For example, significant multipath is observed in scenes with shiny or specular-like floors, or for portions of scenes with concave corners. Also, a gated time of flight camera, for example, may introduce structured, rather than unstructured, per-pixel noise.

Removing the effect of multipath is therefore a crucial component for enhancing the accuracy of time of flight camera systems. However, for many practical applications such as object tracking, hand gesture recognition, and others, the time of flight camera system needs to be both accurate and fast so that accurate depth measurements are output in realtime, for example, at a frame rate of a camera capturing a series of frames for a scene. Many previous approaches involve too much processing to meet realtime deadlines; for example, some require multiple iterations to estimate and re-estimate depth measurements to usefully correct for multipath interference. Although there have been some previous realtime approaches, there are shortcomings in assumptions or generalizations about multipath interference and/or camera response to multipath interference that reduce the quality of the resulting corrections.

### SUMMARY

Systems and methods for correcting multipath interference in determining distances to features in a scene to address the challenges above are disclosed. The system may include a frame buffer arranged to receive, for a frame captured by a time of flight camera, depth imaging measurements for each of a plurality of pixels arranged to measure light received from respective portions of the scene. The system may also include a target portion identifier module configured to identify a plurality of target portions of the scene, each target portion corresponding to portions of the scene measured by two or more of the pixels. The system may also include a target surface generator configured to simulate a plurality of target surfaces, including determining, for each target portion included in the plurality of target portions, a position and an orientation for a respective simulated target surface based on the depth imaging measurements for the measured portions of the scene included in the target portion. The system may also include a reflector selection module configured to select one half or fewer of the plurality of target surfaces as a first plurality of reflector surfaces and, for each target surface included in the target surfaces, select a second plurality of reflector surfaces from the first plurality of reflector surfaces. The system may also include a light transport simulation module configured to, for each target surface included in the target surfaces, simulate, for each reflector surface selected by the reflector selection module for the target surface, a multipath reflection of light emitted by the camera, reflected by the reflector surface to the target surface, and reflected by the target surface to the camera, to generate a simulated multipath response for the target surface. The system may also include a depth measurement correction generation module configured to generate a depth measurement correction for each target surface based on the simulated multipath response generated for the target surface by the light transport simulation module. The system may also include a distance calculation module configured to determine distances for the pixels based on the depth measurement corrections generated by the depth measurement correction generation module for the plurality of target surfaces.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an example of capturing depth imaging measurements using a time of flight depth camera, in which the depth imaging measurements include multipath interference.

FIG. 2 illustrates techniques for capturing depth imaging measurements by integrating light emitted by the time of flight camera shown in FIG. 1 and received by the time of flight camera after being reflected by a scene.

FIG. 3 illustrates a schematic diagram showing features included in an example system for correcting multipath interference in determining distances to features in a scene captured by a time of flight camera, such as the time of flight camera shown in FIG. 1.

FIG. 4 illustrates a flow diagram for example methods for correcting multipath interference in determining distances to features in a scene.

FIG. 5 illustrates an example of identifying target portions of a scene.

FIG. 6 illustrates an example of identifying a plurality of reflector surfaces from a plurality of target surfaces.

FIG. 7 illustrates an example in which a simulated target surface has been generated and a reflector surface has been selected in a field of view for a frame captured by a time of flight camera.

FIG. 8 illustrates an example of simulating an amount of emitted light received at a time of flight camera after being reflected from a target surface to the time of flight camera.

FIG. 9 illustrates an example of simulating an amount of emitted light received at a time of flight camera after reflecting along a path from the time of flight camera to a reflector surface, from the reflector surface to a target surface, and from the target surface back to the time of flight camera.

FIG. 10 illustrates an example in which multipath reflections for multiple reflector surfaces are simulated for a single target surface.

FIG. 11 illustrates a block diagram showing a computer system upon which aspects of this disclosure may be implemented.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

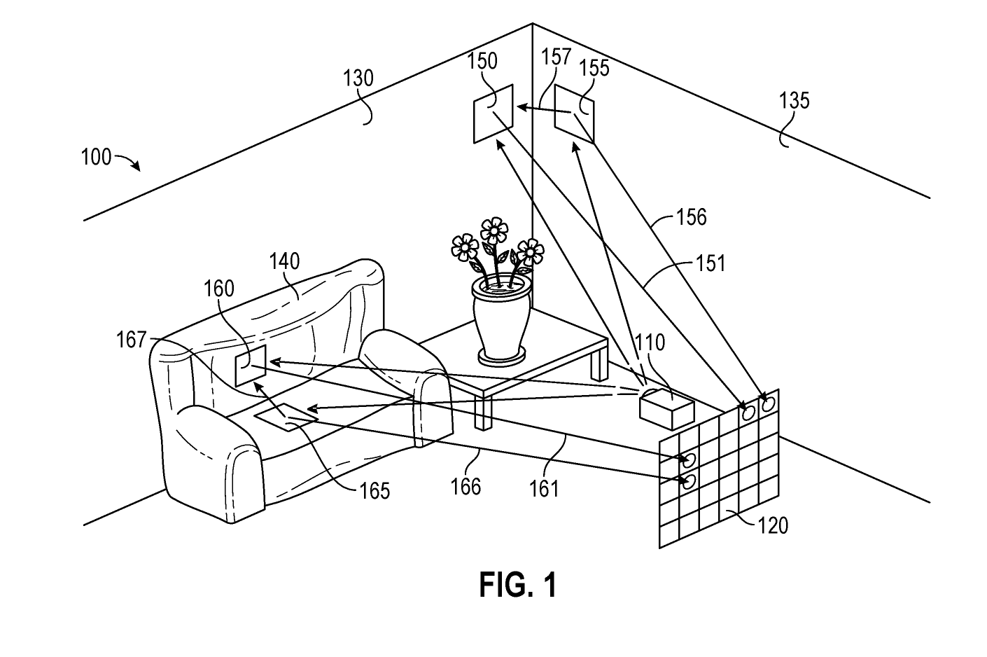

FIG. 1 illustrates an example of capturing depth imaging measurements using a time of flight depth camera, in which the depth imaging measurements include multipath interference. The time of flight depth camera includes, among other features, a light source 110 arranged to transmit light to a scene 100 within a field of view captured via pixel array 120. In some implementations, the light source 110 may be an incoherent light source, such as, but not limited to, a near-infrared light emitting diode (LED). In some implementations, the light source 110 may be a coherent light source, such as, but not limited to, a near-infrared laser. The light source 110 may be modulated under control of the time of flight depth camera. For an implementation using a phase modulation time of flight camera for capturing depth imaging measurements, the light source 110 may be modulated at one or more modulation frequencies. For example, the light source 110 may be modulated at RF frequencies in the MHz range. For an implementation using a gated time of flight camera for capturing depth imaging measurements, the light source 110 may be modulated to transmit pulses with individual durations in the nanosecond range, such as a pulse train.

The time of flight depth camera includes pixel array 120, with pixels arranged to measure light received from respective portions of the scene 100 for generating respective depth imaging measurements. A total angular area for the portions measured by the pixels defines a field of view of the time of flight camera. FIG. 1 provides a simplified illustration of pixel array 120 having only six columns and five rows of pixels. However, pixel array 120 has a larger number of columns and rows of pixels than depicted in FIG. 1. In some implementations, the pixel array 120 includes at least 70,000 pixels. In some implementations, the pixel array 120 includes at least 100,000 pixels. In some implementations, the pixel array 120 includes at least 200,000 pixels. In some implementations, the pixel array 120 includes at least 300,000 pixels. In some implementations, the pixel array 120 includes at least 500,000 pixels. The pixel array 120 may be included in an imaging sensor, and may be included in, for example, a CCD sensor, a CMOS sensor, a Photonic Mixer Device (PMD) sensor. In other implementations, pixel array 120 may be included in other appropriate sensors arranged to detect light reflected from surfaces of objects, people, or other entities within range of the time of flight camera. The camera may also include driver electronics (not illustrated in FIG. 1) which control both the light source 110 and the pixel array 120, for example, to allow highly accurate time of flight measurements and/or phase difference measurements to be made.

The time of flight camera may further include an optical system (not illustrated in FIG. 1) that is arranged to gather and focus light (ambient light and light emitted by the light source 110 and reflected to the camera) from the environment onto the pixel array 120. In some implementations, the optical system may include an optical band pass filter, which may enable only light of the same wavelength as the light source 110 to be received by the pixel array 120. The use of an optical band pass filter may help to suppress background light. To simplify the illustration, image reversal onto pixel array 120 due to an optical system is not illustrated.

In FIG. 1, the time of flight camera captures depth imaging measurements for a frame by emitting light using light source 110, measuring light received from portions of the scene 100 (including reflections of the emitted light) with respective pixels included in the pixel array 120, and generating respective depth imaging measurements based on the measurements by the pixels. The time of flight camera is configured to capture and provide depth imaging measurements for successive frames at a frame rate, which may be adjustable. In some implementations, the frame rate may be at least 5 fps (frames per second). In some implementations, the frame rate may be at least 10 fps. In some implementations, the frame rate may be at least 15 fps. In some implementations, the frame rate may be at least 20 fps. In some implementations, the frame rate may be at least 30 fps. In some implementations, the frame rate may be at least 60 fps. In some implementations, the frame rate may be at least 100 fps.

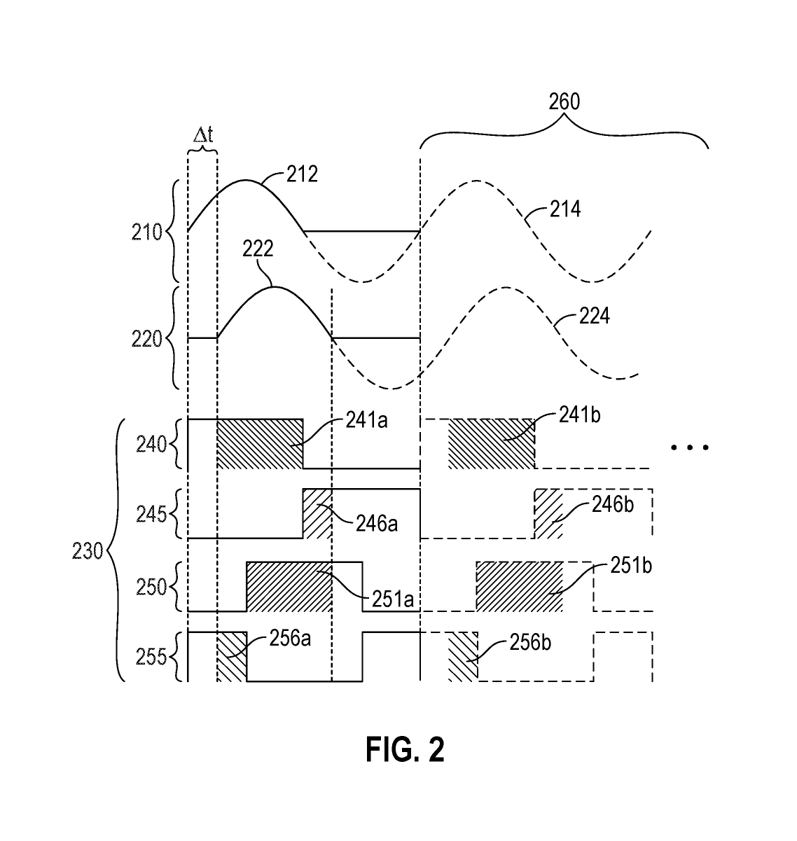

In some implementations, the depth imaging measurements provided for a frame captured by the time of flight camera include one or more depth imaging measurements for each of the pixels included in the pixel array 120. In some implementations, depth imaging measurements for each pixel may include an estimated distance between a surface in the portion of the scene 100 being measured by the pixel, an estimated brightness of the surface, and/or an estimated albedo of the surface. In some implementations, depth imaging measurements for each pixel may include a multidimensional distance measurement response reflecting varying modulation schemes and/or accumulation schemes used by the time of flight camera to capture depth imaging measurements for a frame. Example techniques for capturing and providing depth imaging measurements are discussed below in connection with FIG. 2.

The example scene 100 illustrated in FIG. 1 includes, among other features, a rear wall 130, a side wall 135, and a seat 140. Although FIG. 1 illustrates using the time of flight camera in an indoor environment, the techniques described herein may be used in other environments including outdoor environments. Light emitted by the light source 110 travels along a direct path between the time of flight camera and a surface 150 on the rear wall 130 to be reflected by the surface 150 back to the time of flight camera along ray or line segment 151. The reflected light is measured by a corresponding pixel in the pixel array 120. A portion of light received by the time of flight camera that was emitted by the light source 110 and travels along a direct path between a surface and the time of flight camera may be referred to as a “direct component” of the received light, or as “direct illumination.” Likewise, light emitted by the light source 110 travels along a direct path between the time of flight camera and a surface 155 on the side wall 135 to be reflected by the surface 155 back to the time of flight camera along ray or line segment 156, with the reflected light measured by a corresponding pixel in the pixel array 120.

In addition, light emitted by the light source 110 travels along a secondary or indirect path in which the emitted light is reflected by the surface 155 along ray or line segment 157 to the surface 150. This can result in an increase in a total amount of light emitted by the light source 110 that is received by the surface 150 and also can increase a total amount of light that is reflected by the surface 150 to the time of flight camera along ray or line segment 156. There may be many additional indirect paths, with two or more bounces, that further increase the total amount of light emitted by the light source 110 that is reflected from the surface 150 and measured at the time of flight camera. The cumulative increase along all such indirect paths may be referred to as “multipath interference,” “multipath bias,” or “multipath contamination.” A portion of light that was emitted by the light source 110 and that travels along an indirect path before being received by the time of flight camera may be referred to as a “multipath component” or “indirect component” of the received light, or as “multipath illumination” or “indirect illumination.” In some situations, such as for portions of a scene in or around a convex corner, a multipath component of light received by a pixel may be greater than a direct component; however, in most cases the multipath component is small compared to the direct component. In addition to increasing an amount of reflected light received for a portion of a scene, multipath components are delayed relative to the direct component, due to their paths being longer. Thus, the multipath component further obscures the direct component by spreading out the received reflected light over time.

FIG. 1 further illustrates a surface 160 of seat 140 for which light reflected back to the time of flight camera along ray or line segment 161 includes a multipath component due to light emitted by the light source 110 being reflected by a surface 165 of the seat 140 along ray or line segment 167 to the surface 160. Also, although not illustrated in FIG. 1, measurements for other portions of the scene 100, including surfaces 155 and 165, may likewise include multipath interference that affects determining information about the scene 100 based on depth imaging measurements contaminated by multipath interference.

FIG. 2 illustrates techniques for capturing depth imaging measurements by integrating light emitted by the time of flight camera shown in FIG. 1 and received by the time of flight camera after being reflected by a scene. FIG. 2 illustrates an emitted light 210 that is emitted by a time of flight camera to illuminate a scene, such as light emitted by light source 110 in FIG. 1. For an implementation using a gated time of flight camera, an emitted light pulse 212 (shown for a first illumination period) is used to illuminate a scene. Although a square pulse, with very rapid rise and fall in amplitude, might be preferred for a gated time of flight camera, response characteristics for a light source may result in a different pulse profile (amplitude over time), such as the sinusoidal pulse profile illustrated for emitted light pulse 212. For an implementation using a phase modulation time of flight camera, modulated emitted light 214 is used to illuminate the scene. For example, the light may be modulated at a frequency f with a sinusoid waveform having an amplitude varying approximately according to cos(f×t) or 1+cos(f×t). Response characteristics for a light source may result in a waveform that deviates from an ideal sinusoid.

After a brief time delay Δt, corresponding to an amount of time for the emitted light 210 to travel along a path and reach a surface in a portion of a scene (directly or indirectly) and for the emitted light 210 to be reflected from the surface back to the time of flight camera, reflected light 220 is received at a detector included in the time of flight camera, such as the pixel array 120 illustrated in FIG. 1. For an implementation using a gated time of flight camera, the reflected light 220 is received as a reflected light pulse 222 with a pulse profile corresponding to the emitted light pulse 212. For an implementation using a phase modulation time of flight camera, the reflected light 220 is received as a modulated reflected light 224, modulated at the same frequency as its corresponding modulated emitted light 214, but with a phase difference from the modulated emitted light 214 corresponding to the time delay Δt.

A path length (which may be referred to as D) for the reflected light 220 may be determined based on the time delay Δt according to the formula D=Δt×c (with c being the speed of light). For a direct, or “one bounce,” path, the distance d between the time of flight camera and a reflecting surface would be half the path length D, or d=D/2. The amplitude of the reflected light 220 received by a pixel is reduced, relative to an amplitude of the emitted light 210, in proportion to the square of the path length. However, it should be understood that various properties of a scene being measured by the depth camera, such as, but not limited to, orientations of surfaces to the camera and/or one another, albedo of surfaces, transparency of objects in the scene, and/or specularity of surfaces, may result in the amplitude being further reduced and affect the degree of the reduction in amplitude.

Due to such reduction in amplitude resulting in a weak signal, even for a direct component, along with other design considerations, it is impractical for a time of flight camera to directly measure the time delay Δt. Instead, the time of flight camera captures depth imaging measurements for a pixel by performing a plurality 230 of integrations 240, 245, 250, and 255 of reflected light 220 according to respective integration schemes. Each integration scheme may define and operate according to a modulation scheme for emitted light 210 (for example, a duration and/or amplitude of emitted light pulse 212, a frequency and/or amplitude of modulated light pulse 214, or, for measuring ambient light, not emitting light), a light measurement or accumulation scheme (for example, determining relative timings and durations of accumulation intervals and/or a charge accumulation rate), and/or a number of illumination periods (for example, a number of additional illumination periods 260 after the first illumination period).

In the example illustrated in FIG. 2, each of the plurality 230 of light integrations 240, 245, 250, and 255 includes one or more accumulation intervals during which a charge is accumulated for the integration in proportion to an amount of light received by a pixel. For example, a high speed electronic shutter, with nanosecond-scale response time, may be used to control when a photodiode is exposed to light, or a switch may be used to enable or disable charge accumulation. In the example illustrated in FIG. 2, light integrations 240, 245, 250, and 255 operate according to different light measurement or accumulation schemes with different relative timings and durations of accumulation intervals. A first light integration 240 includes an accumulation period 241a, a second light integration 245 includes an accumulation period 246a, a third light integration 250 includes an accumulation period 251a, and a fourth light integration 255 includes an accumulation period 256a. The accumulation periods 241a, 246a, 251a, and 256a each begin at a predetermined period to time relative to emission of emitted light pulse 212 or in relation to a phase of modulated emitted light 214 (depending on whether a gated or phase modulated time of flight camera is being used). Furthermore, the accumulation periods 241a, 246a, 251a, and 256a each end at a predetermined period to time relative to emission of emitted light pulse 212 or in relation to a phase of modulated emitted light 214. For example, in relation to a phase of modulated emitted light 214, accumulation period 241a starts at 0° and ends at 180°, accumulation period 246a starts at 180°and ends at 0°, accumulation period 251a starts at 90° and ends at 270°, and accumulation period 256a starts at 270° and ends at 90°.

In FIG. 2, portions of the accumulation periods 241a, 246a, 251a, and 256a during which reflected light pulse 222 results in charge accumulation are indicated by shading; similar charge accumulation would occur for modulated reflected light 224. In general, the amount of photons received by a pixel in a single accumulation period does not result in a useful amount of charge being accumulated. Thus, additional illumination periods 260, after the first illumination period, are performed for the light integrations 230, with corresponding additional modulations for the emitted light 210, and further charge accumulation during respective accumulation periods (such as accumulation periods 241b, 246b, 251b, and 256b), resulting an increased total charge accumulated during a total duration of a light integration. Also, in some implementations, two or more light integrations can be performed concurrently, reducing the time to perform the plurality of light integrations 230 for a frame or allowing light integrations to be performed for a greater number of illumination periods. Also, although not illustrated in FIG. 2, one or more additional light integrations may be performed without corresponding emission of light by the time of flight camera. This information may be used to determine an effect on, or contribution to, depth imaging measurements due to ambient light while capturing the frame, to remove an ambient lighting component from the depth imaging measurements provided for the frame (a process which may be referred to as “ambient subtraction” that yields “ambient subtracted” depth imaging measurements).

It is noted that FIG. 2 only illustrates a reflected light 220 that traveled along a single path (whether directly or indirectly). In general, reflected light 220 is representative of only one of many reflections of emitted light 220 received by a pixel. As discussed above in connection with FIG. 1, a pixel may receive and measure, for its corresponding portion of a field of view, a direct component (or, in some cases, multiple direct components, if the portion includes surfaces at multiple distances from the time of flight camera) and one or more multipath components delayed relative to the direct component. As a result, the waveform for the light actually received by a pixel is more complex and ambiguous than the simplified example illustrated in FIG. 2, which has a corresponding effect on the charges accumulated for each of the plurality of light integrations 230. Also, it should be understood that modulation of emitted light 210, which results in the reflected light 220 received by one pixel in FIG. 2, also results in reflected light used to generate depth imaging measurements. As a result, the time of flight camera generates depth imaging measurements for a plurality of pixels for each captured frame.

For each of the plurality of light integrations 230 performed for a pixel for capturing a frame, a respective charge is accumulated and measured. For purposes of this discussion, charges measured by light integrations 240, 245, 250, and 255 for a pixel will respectively be referred to as Q1, Q2, Q3, and Q4. The time of flight camera generates depth imaging measurements for the pixel based on the measured charges. In some implementations, where there is a number N of light integrations 230 with N measured charges, a depth imaging measurement for each pixel may be provided as an N-dimensional vector with components corresponding directly to the N measured charges. For example, a four-dimensional vector (Q1, Q2, Q3, Q4) may be returned for the example illustrated in FIG. 2. In some implementations, a number N of light integrations 230 with N measured charges may be processed by the time of flight camera to provide a depth imaging measurement for each pixel as an M-dimensional vector, where M is less than N. For example, various techniques are available that yield an ambient subtracted M-dimensional vector with an ambient component removed. As another example, a phase modulated time of flight camera may perform three sets of four integration periods similar to those illustrated in FIG. 2. Each set may modulate emitted light 214 at a different frequency, and include another integration period for ambient light measurement, as well as provide a 6-dimensional vector depth imaging measurement for each pixel. This can result in an ambient subtracted phase (or distance) and amplitude pair for each of the three frequencies. The time of flight camera may perform other adjustments and/or corrections in the process of generating the depth imaging measurements provided for a frame including, but not limited to, adjustments for per-pixel variations (for example, for dark current noise or “flat-fielding” to correct for variations in pixel sensitivity to light and/or nonuniformity in light transmission by an optical system across a field of view), and/or adjustment of “outlier” depth imaging measurements that appear to be incorrect or inconsistent with other depth imaging measurements.

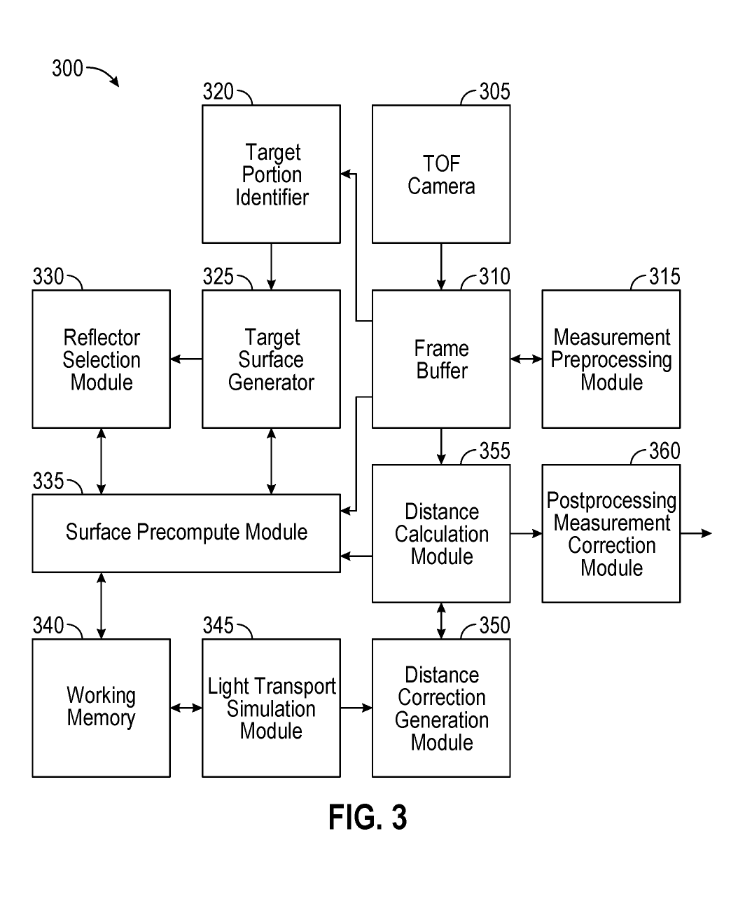

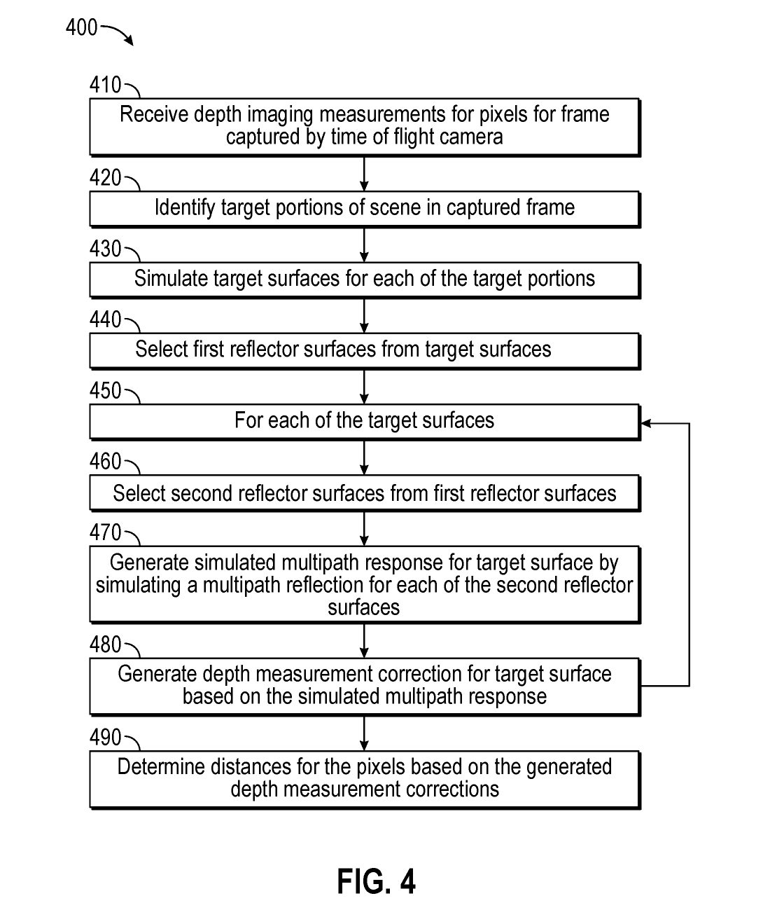

FIG. 3 illustrates a schematic diagram showing features included in an example system 300 for correcting multipath interference in determining distances to features in a scene captured by a time of flight camera, such as the time of flight camera shown in FIG. 1. In order to provide the reader with a greater understanding of the disclosed implementations, FIG. 3 will also be described in conjunction with FIGS. 4-10 throughout this description.

The system 300 includes a time of flight (TOF) camera 305 that operates much as described above in connection with FIGS. 1 and 2. The time of flight camera 305 is configured to generate, for a frame captured by the time of flight camera 305, depth imaging measurements for each of a plurality of pixels arranged to measure light received from respective portions of the scene. The depth imaging measurements generated by the time of flight camera 305 are contaminated by multipath interference which, left uncorrected, may lead to significant errors in estimated distances between the time of flight camera and portions of the scene. Much as discussed above, the time of flight camera 305 may be configured to capture and provide depth imaging measurements for successive frames at a frame rate, and as a result impose realtime processing constraints and/or deadlines on correcting multipath interference for each frame captured by the time of flight camera 305.

FIG. 4 illustrates a flow diagram for example methods for correcting multipath interference in determining distances to features in a scene, which may be performed, for example, using the system 300 illustrated in FIG. 3. Each of the steps presented in FIG. 4 will be referred to throughout the description in conjunction with FIGS. 3 and 5-10 in order to better provide the reader with clarity regarding the disclosed implementations.

Referring to FIG. 4, at 410 the method 400 includes receiving depth imaging measurements for pixels for a frame captured by the time of flight camera 305; for example, receiving, for the frame captured by the time of flight camera 305, the depth imaging measurements for each of a plurality of pixels arranged to measure light received from respective portions of the scene. This step is also illustrated in FIG. 3, where it can be seen that the system 300 includes a frame buffer 310 arranged to receive and store, for a frame (or each frame) captured by the time-of-flight camera 305, depth imaging measurements for each of the plurality of pixels included in the time of flight camera 305. The frame buffer 310 may be provided by a portion of a main memory, such as a DRAM (dynamic random access memory), used by other components included in the system 300. The frame buffer 310 may be provided by a memory device included in the time of flight camera 305. In some implementations, the frame buffer 310 may be used to store depth imaging measurements for multiple frames at a time.

In some implementations, the system 300 may include a measurement preprocessing module 315 arranged to obtain depth imaging measurements for a frame stored in the frame buffer 310, and perform operations using the obtained depth imaging measurements before system 300 identifies target portions of the scene based on depth imaging measurements obtained from the frame buffer 310. In some implementations, operations performed by the measurement preprocessing module 315 may modify the depth imaging measurements stored in frame buffer 310. For example, measurement preprocessing module 315 may perform corrections or adjustments of depth imaging measurements. Some of these corrections can include, but are not limited to, adjustments for per-pixel variations (for example, for dark current noise or “flat-fielding” to correct for variations in pixel sensitivity to light and/or nonuniformity in light transmission by an optical system across a field of view), and/or adjustment of “outlier” depth imaging measurements that appear to be incorrect or inconsistent with other depth imaging measurements. In some implementations, measurement preprocessing module 315 may calculate initial distance values for pixels. In some implementations, measurement preprocessing module 315 may perform edge detection based on the obtained depth imaging measurements, which may be used by, among other components of the system 300, a target portion identifier 320. Some or all of the measurement preprocessing module 315 may be included in the time of flight camera 305.

Referring again to FIG. 4, at 420 the method 400 also includes identifying target portions of the scene captured in the frame for which depth imaging measurements were received at 410; for example, by identifying a plurality of target portions of the scene, each target portion corresponding to portions of the scene measured by two or more of the pixels corresponding to the depth imaging measurements received at 410. As shown in FIG. 3, the system 300 includes the target portion identifier module 320, which is arranged to identify a plurality of target portions of the scene, each target portion corresponding to portions of the scene measured by two or more of the pixels included in the time of flight camera 305. In some implementations, target portion identifier module 320 may be arranged to identify one or more of the target portions based on depth imaging measurements obtained from the frame buffer 310 and/or results provided by the measurement preprocessing module 315. By identifying target portions corresponding to two or more pixels, the resulting number of target portions is smaller than the number of pixels.

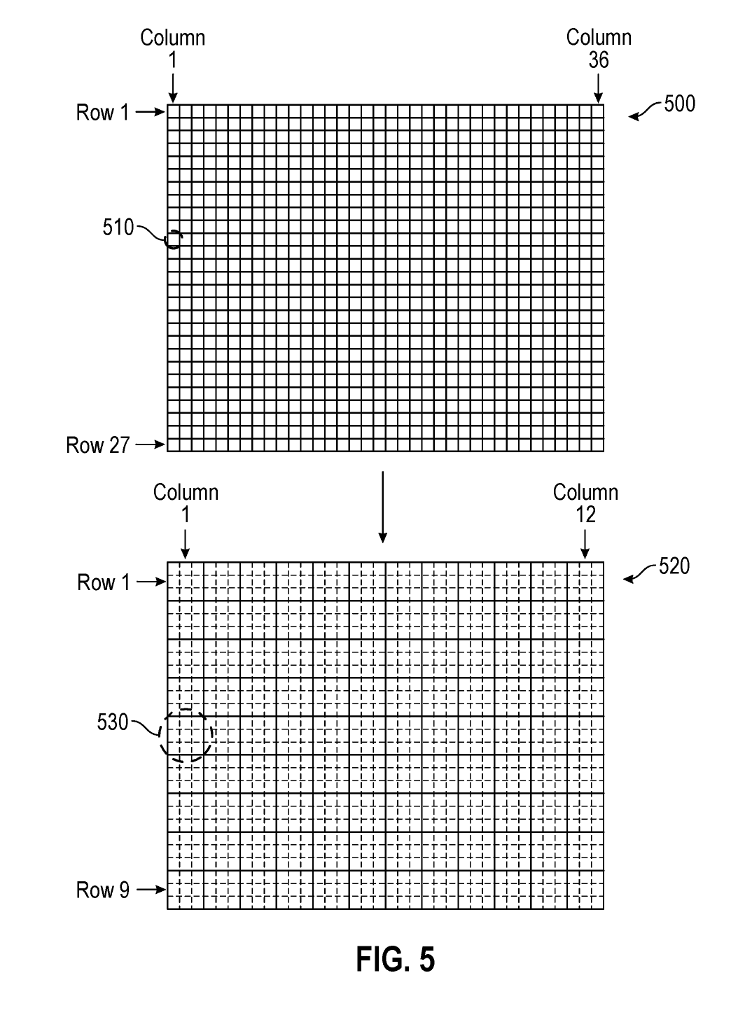

For purpose of clarity, FIG. 5 illustrates an example of identifying target portions of a scene. At the top of FIG. 5, frame 500 represents a plurality of pixels included in the time of flight camera 305 and arranged to measure light received from respective portions of a scene in a frame captured by the time of flight camera and for which respective depth imaging measurements are stored in the frame buffer 310. Much as with the pixel array 120 illustrated in FIG. 1, the pixels are arranged into rows and columns covering a field of view captured for the frame, including, for example, pixel 510 located in column 1, row 11. The frame 500 includes 36 columns of pixels and 27 rows of pixels (for a total of 972 pixels and respective portions of the scene in frame 500). Much as with pixel array 120 in FIG. 1, reduced numbers of columns and rows of pixels are illustrated for frame 500 to simplify illustration and discussion of the disclosed techniques, and that the disclosed techniques are applicable to frames with much greater numbers of pixels.

At the bottom of FIG. 5, target portion map 520 illustrates identification of target portions of the scene captured in frame 500. In this example, a simple approach has been used to identify target portions: the scene in frame 500 has been divided into adjacent columns that are X pixels wide and adjacent rows that are Y pixels high; in this case X=3 and Y=3, but other values may be used for X and Y, and X and Y may have different values. As a result, 108 target portions have been identified, arranged into 12 columns and 9 rows of target portions, that each correspond to a portion of the scene measured by nine pixels arranged in a 3×3 block of pixels. Although in this approach all of the pixels in frame 500 are included in the identified target areas, other approaches may identify a plurality of target portions that do not include all of the pixels. Also, although in this approach none of the identified target areas overlap, other approaches may result in overlapping target portions. In addition, while in this approach rectangular target areas are identified, other approaches may result in target portions with other shapes, including irregular shapes. For example, edge detection may be performed to identify groups of pixels that are likely to be part of a single surface. Furthermore, although in target portion map 520 the identified target portions are all the same size and area (which allows for simplifications of certain later computations), other approaches may identify target portions of different sizes or areas. In some circumstances, a target portion may later be removed for the identified plurality of target portions; for example, depth imaging measurements corresponding to a target portion may be determined to be unreliable. In some circumstances, two or more target portions may later be replaced by a single target portion, such as a larger target portion covering the target portions it replaces.

Referring again to FIG. 4, at 430 the method 400 includes simulating target surfaces for each of the target portions identified at 420; for example, by simulating a plurality of target surfaces, including determining, for each target portion included in the plurality of target portions identified at 420, a position and an orientation for a respective simulated target surface based on the depth imaging measurements received at 410 for the measured portions of the scene included in the target portion. As shown in FIG. 3, the system 300 includes a target surface generator 325 configured to simulate a plurality of target surfaces, including determining, for each target portion included in the target portions, a position and an orientation for a respective simulated target surface based on the depth imaging measurements for the measured portions of the scene included in the target portion. The target surfaces may be simulated in a piecewise fashion, rather than simulating all, or even any, of the plurality of target surfaces before selecting reflector surfaces from the target surfaces. For example, a “lazy” approach to simulating a target surface may be used, in which a position and orientation are not determined until a target surface is involved in light transport simulation.

In some implementations, a surface precompute module 335 may be arranged to, based on information defining a target portion (for example, which pixels are included in the target portion), depth imaging measurements obtained from frame buffer 310, and/or estimated distances obtained from distance calculation module 355, estimate or otherwise determine a position and an orientation for a simulated target surface. In some implementations, an orientation for a target surface is determined based on central differences on depth by taking a cross product of positional differences of adjacent pixels or other elements. For example, to determine a normal for a target surface including a pixel at a position (x,y), a point A may be determined by unprojecting (x,y) into 3D space, a point B by unprojecting (x−1,y), a point C by projecting (x,y−1), and generating a normal from a cross product of a first spanning vector (C-A) and a second spanning vector (B-A). In another example, a similar approach with longer spanning vectors may be used, such as with the pairs ((x−1,y),(x+1,y)) and ((x,y−1),(x,y+1)), and falling back to a shorter spanning vector if a longer spanning vector is determined to be based on an invalid depth imaging measurements for a pixel, such as using the pair ((x,y),(x+1,y)) if (x−1,y) is determined to be invalid. In some implementations, a position and an orientation for a target surface is determined by performing a least squares fitting based on the depth imaging measurements for the measured portions of the scene included in the target portion, or values determined from those depth imaging measurements (such as distances or 3D coordinates), to determine a best fitting 3D plane. Based on the determined 3D plane, a surface normal (an orientation) and a position may be determined for the simulated target surface. In such implementations, in the course of simulating, or attempting to simulate, a target surface, the target surface and its respective target portion may be removed; for example, as a result of an error for the least squares fit exceeding a threshold amount. The surface precompute module 335 may also be arranged to store a position and an orientation determined for a target surface in a working memory 340 for later use or reuse. In some simulations, in the course of simulating a target surface, the target surface and its respective target portion may be merged with a neighboring target surface and its target portion; for example, as a result of the two target surfaces having substantially similar orientations.

Identifying a number of target portions that is smaller than the number of pixels, at 420 (see FIG. 4) or with target portion identifier 320 (see FIG. 3), is advantageous for light transport simulations performed using the target portions and their corresponding target surfaces. The complexity of the light transport simulations is O(n²), which makes realtime multipath interference correction by simulating light transport between the much larger number of pixels impractical or impossible. The smaller number of target portions offers an effective and beneficial tradeoff providing benefits of use of realistic light transport simulations in realtime.

Identifying a number of target portions that is smaller than the number of pixels, at 420 or with target portion identifier 320, also reduces an amount of corresponding data stored in memory for the target portions and/or their associated target surfaces. This technique can allow the data for the target surfaces used by the light transport simulation module 345 to fit in the working memory 340 and as a result avoids memory access latencies for accessing other, slower, memories that may cause slowdowns that prevent realtime processing, and also avoids using bandwidth for such memories that might instead be used by other components or processing.

Simulating target surfaces that correspond to portions of the scene measured by two or more pixels offers a reduction in noise in the original depth imaging measurements that may tend to reduce an amount and/or degree of errors in light transport simulations based on noisier information.

Referring again to FIG. 4, at 440 the method 400 also includes selecting a first plurality of reflector surfaces from the target surfaces simulated at 430. As depicted in FIG. 3, the system 300 includes a reflector selection module 330 configured to select one half or fewer of the target surfaces as a first plurality of reflector surfaces. In some implementations, one half or fewer of the target surfaces are selected as the first plurality of reflector surfaces. In some implementations, one fourth or fewer of the target surfaces are selected as the first plurality of reflector surfaces. In some implementations, one ninth or fewer of the target surfaces are selected as the first plurality of reflector surfaces. In some implementations, one sixteenth or fewer of the target surfaces are selected as the first plurality of reflector surfaces. In some implementations, one twenty-fifth or fewer of the target surfaces are selected as the first plurality of reflector surfaces. In some implementations, a reflector surface may be selected before its respective target surface has been simulated; for example, the reflector surfaces, after being selected, may be the first, or among the first, simulated target surfaces. In some implementations, target surface data and/or reflector surface data obtained from the surface precompute module 335 may be used to identify target surfaces that are undesirable or unsuitable for use as reflector surfaces. For example, target surfaces with an estimated reflectivity less than or equal to a threshold reflectivity or target portions for which the surface precompute module 335 is unable to accurately estimate an orientation. Alternatively, reflector portions may be selected from the target portions identified at 420 (see FIG. 4) and/or target portion identifier 320 (see FIG. 3), although this amounts to little difference, as corresponding surfaces are still simulated and used for light transport simulation.

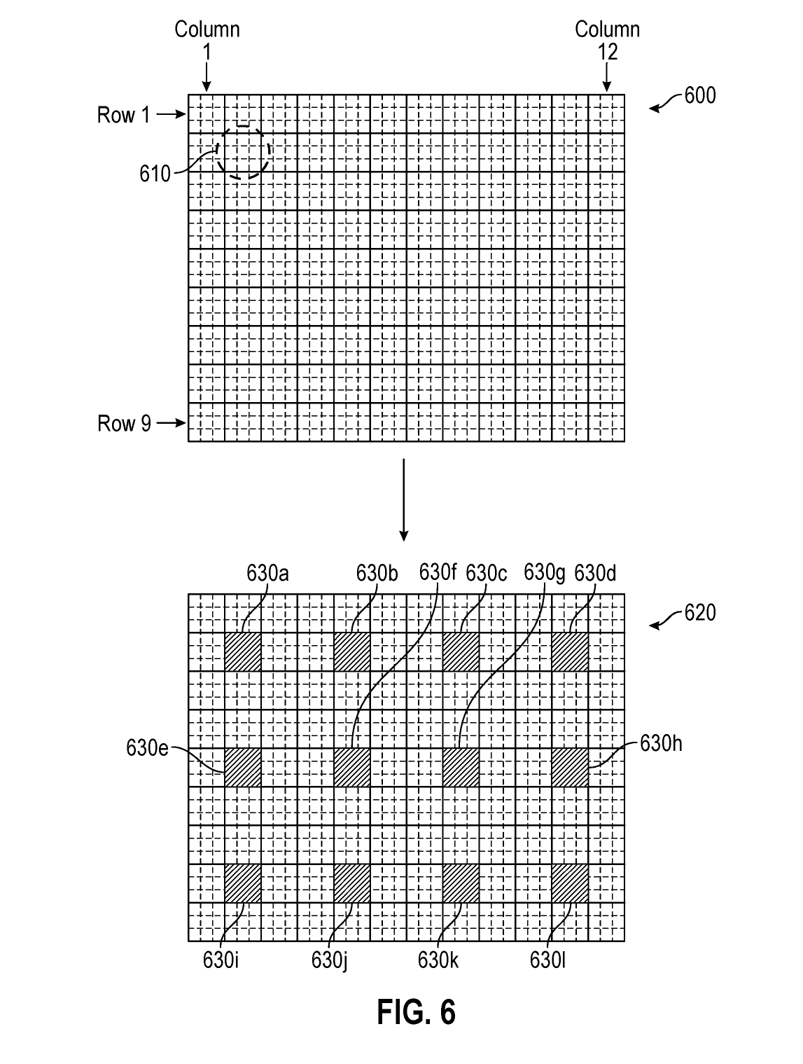

FIG. 6 illustrates an example of identifying a plurality of reflector surfaces from a plurality of target surfaces. Target portion map 600 at the top of FIG. 6 is essentially the same as the target portion map 520 at the bottom of FIG. 5; both target portion maps have divided a field of view into 12 columns and 9 rows of target portions each corresponding to a 3×3 block of nine pixels. At 430 (see FIG. 4) and/or using target surface generator 325 (see FIG. 3), a corresponding target surface, including target surface 610, is, or will be, simulated for each of the target portions in target portion map 600. In a target surface map 620 at the bottom of FIG. 6, showing target surfaces corresponding to the target portions in the target portion map 600, a plurality of reflector surfaces 630a-6301 is selected from the plurality of target surfaces. In this example, a simple approach is applied: the reflector surfaces are subsampled from the target surfaces. In this specific example, one target surface from each 3×3 block of target surfaces is selected as a reflector surface, resulting in only one ninth of the target surfaces being selected as the plurality of target surfaces. There may be other sizes for blocks of target surfaces, such as, but not limited to, 2×2 blocks (resulting in one reflector surface for each 4 target surfaces), 4×4 blocks (resulting in one reflector surface for each 16 target surfaces), or 5×5 blocks (resulting in one reflector surface for each 25 target surfaces). Although such subsampling to select the reflector surfaces from square blocks of target surfaces is useful for obtaining an even distribution of reflector surfaces, other approaches to selecting a subset of the target surfaces as reflector surfaces may be used. For example, reflector surfaces may be randomly selected, including random selection of one or more reflector surfaces from each N×N or N×M block of target surfaces.

Selecting a subset of the target surfaces as reflector surfaces allows for reducing the amount of computation involved, as no new surfaces, and related computation involved in simulating new surfaces, is required for the reflector surfaces. Additionally, using a number of reflector surfaces that is smaller than the number of target surfaces, for example, by selecting one half or fewer of the target surfaces, offers a substantial reduction in the complexity of light transport simulations and further improves upon the reduction in complexity achieved by using target surfaces instead of the underlying individual pixels. The reduction in complexity is linearly proportional to the reduced number of reflector surfaces. This reduction and complexity, and improved ability in achieving realtime processing, is an effective and beneficial tradeoff providing benefits of use of realistic light transport simulations in realtime.

Selecting a reduced number of reflector surfaces reduces the amount of working memory needed to store the data that is most frequently and repeatedly used for light transport simulations. Data for the plurality of reflector surfaces is used for each target surface when generating simulated multipath responses; in contrast, data for an individual target surface (that was not selected as a reflector surface) is accessed a much smaller number of times. Thus, ensuring that the data for the reflector surfaces fits in, and remains in, working memory 340 can offer a significant speedup in processing, allow the working memory 340 to be smaller, and/or allow other portions of the working memory 340 to be available for other processing activities, all of which improve realtime operation and power demands.

Referring again to FIG. 3, it can be seen that the system 300 includes the surface precompute module 335 arranged to precompute target surface data for target surfaces, including positions and orientations of target surfaces for target surface generator 325, and to precompute reflector surface data for reflector surfaces, such as the first reflector surfaces selected at 440 and/or by reflector selection module 330. Much as discussed above, the target surface data and reflector surface data may be precomputed based on information defining a respective target portion (for example, which pixels are included in the target portion), depth imaging measurements obtained from frame buffer 310, and/or estimated distances for pixels and/or estimated illumination of pixels obtained from distance calculation module 355.

The target surface data precomputed by the surface precompute module 335 for a simulated target surface may include, for example:
An estimated position for the target surface (xᵢ), such as a 3D coordinate (X, Y, Z). In some implementations, the 3D coordinate is in a coordinate system for the time of flight camera 305. The position may correspond to a centroid of a respective target portion. It is understood that this position may be inaccurate due to multipath interference.
A unit normal vector for the target surface (nᵢ), which also defines an orientation for the target surface. Precomputation of the surface normal may overlap with estimating or otherwise determining the position for the target surface. For example, much as discussed above, a best fitting 3D plane may be determined, such as by performing a least squares fitting based on depth imaging measurements obtained from frame buffer 310 and/or estimated distances to pixels obtained from distance calculation module 355 for pixels included in the corresponding target portion. Much as discussed above, as a result of an error for a least squares fit exceeding a threshold amount, the surface precompute module 335 determines, and indicates to other modules, that it is unable to accurately estimate a surface normal and/or 3D coordinate for the target surface.
A distance from the time of flight camera to the target surface (dᵢ). For example, the distance may be calculated based on the 3D coordinate for the target surface by applying a formula such as

distance=\sqrt{X²+Y²+Z²}
A target scale factor, calculated according to:

$$\frac{1}{{n}_{i} \cdot {\hat{x}}_{i}}$$

in which nᵢ is the above unit normal vector for the target surface, and \hat{x}ᵢ is a unit view/light direction to the position of the target surface
An illumination (Lᵢ) towards the target surface, reflecting variations in illumination by a light source included in the time of flight camera 305 over its field of view (for example, a central portion of the field of view may be more strongly illuminated).
An estimated albedo (pᵢ) for the target surface. It is understood that this albedo may be inaccurate due to multipath interference

The reflector surface data precomputed by the surface precompute module 335 for a reflector surface may include the above target surface data for its respective target surface, and additionally include, for example:
A reflector scale factor, which is a reflectivity for the reflector surface times a solid angle or angular area of the reflector surface.

The system 300 may be configured to use the surface precompute module 335 to precompute reflector surface data for all of the first reflector surfaces selected at 440 and/or by reflector selection module 330 and store the resulting reflector surface data in the working memory 340 before simulating multipath contributions involving the reflector surfaces at 470 and/or with the light transport simulation module 345. Much as discussed above, the reflector surface data for the first reflector surfaces is accessed frequently and repeatedly for light transport simulations. Accordingly, it is beneficial to precompute the reflector surface data for the first reflector surfaces, store the resulting reflector surface data in the working memory 340, and keep the reflector surface data stored in the working memory 340 for all of the light transport simulations performed at 470 and/or by the light transport simulation module 345 for the frame, particularly where working memory 340 offers lower latencies than other memories included in system 300.

In some implementations, the system 300 may include a low-latency working memory 340 that is coupled to the light transport simulation module 345 and arranged to provide data stored therein to the light transport simulation module 345. The working memory 340 may further be arranged to receive and store data provided by the light transport simulation module 345, such as intermediate values generated by the light transport simulation module 345. In some implementations, working memory 340 may be implemented with an SRAM (static random access memory). For example, working memory 340 may be provided by a CPU cache memory, and strategies may be employed that ensure that certain data (such as, but not limited to, reflector surface data) remains in the cache memory. As another example, many DSPs include a small low-latency memory (such as, but not limited to, a single-cycle access memory) to perform high speed operations on a working set of data. By using a low-latency working memory 340, system 300 is more likely to realize realtime deadlines for correction of multipath interference, and also can reduce bandwidth demanded from other memories that may be shared with other modules included in the system 300. In some implementations, a higher latency memory may be used to store data used or generated by the light transport simulation module 345.

Referring again to FIG. 4, at 450 the method 400 includes performing 460, 470, and 480 for each of the target surfaces. In some implementations, this may be performed by simple iteration through the target surfaces. In some implementations, multiple target surfaces may be processed in parallel; for example, multiple processing units (for example, general purpose processors and/or processor cores, DSPs (digital signal processors) and/or DSP cores, FPGAs (field programmable gate arrays), ASICs (application specific integrated circuits), or other circuits) may be used to perform such parallel processing. In particular, parallel processing of the simulations done at 470 can offer significant benefits towards achieving realtime processing. In an implementation that performs “lazy” simulation of target surfaces, the surface precompute module 335 can be used to generate target surface data for each target surface immediately prior to its use at 460, 470, and 480.

Thus, at 460, the method 400 includes, for a current target surface, selecting a second plurality of reflector surfaces from the first plurality of reflector surfaces selected at 440. As depicted in FIG. 3, the reflector selection module 330 is further configured to, for each target surface included in the plurality of target surfaces, select a second plurality of reflector surfaces from the first plurality of reflector surfaces. In a number of circumstances, it is not useful to use a reflector surface in connection with the current target surface, and accordingly it is useful to exclude that reflector surface from the second plurality of target surfaces. As one example, the current target surface may be one of the first plurality of reflector surfaces. In some implementations, a reflector surface may be excluded from the second plurality of reflector surfaces in response to a determination that the normal vector for the reflector surface does not face the normal vector for the current target surface (in which case, there would be no multipath contribution from the reflector for the current target surface). For example, a vector x^{ij} between the current target surface and a reflector surface may be calculated, and for a reflector surface (with a surface normal nⱼ) and the current target surface (with a surface normal nᵢ), the reflector surface may be included in the second plurality of reflector surfaces if both (−nᵢ•x^{ij})>0 and (nⱼ•x^{ij})>0. It should be understood that non-zero values may also be used for these comparisons, to filter out reflector surfaces that, at best, will make only a very minor multipath contribution for the current target surface. In some implementations, a check may be performed to determine if there is an estimated occlusion in the scene between a reflector surface and the current target surface, and if so, the reflector surface is excluded from the second plurality of target surfaces. It is understood that in many circumstances, the second set of reflector surfaces may include all of the first plurality of reflector surfaces.

A benefit obtained by excluding one or more of the first plurality of reflector surfaces from the second plurality of reflector surfaces is reducing an amount of computation for the current target surface by eliminating reflector surfaces that are irrelevant or are expected to make no, or a very small, multipath contribution for the current target surface.

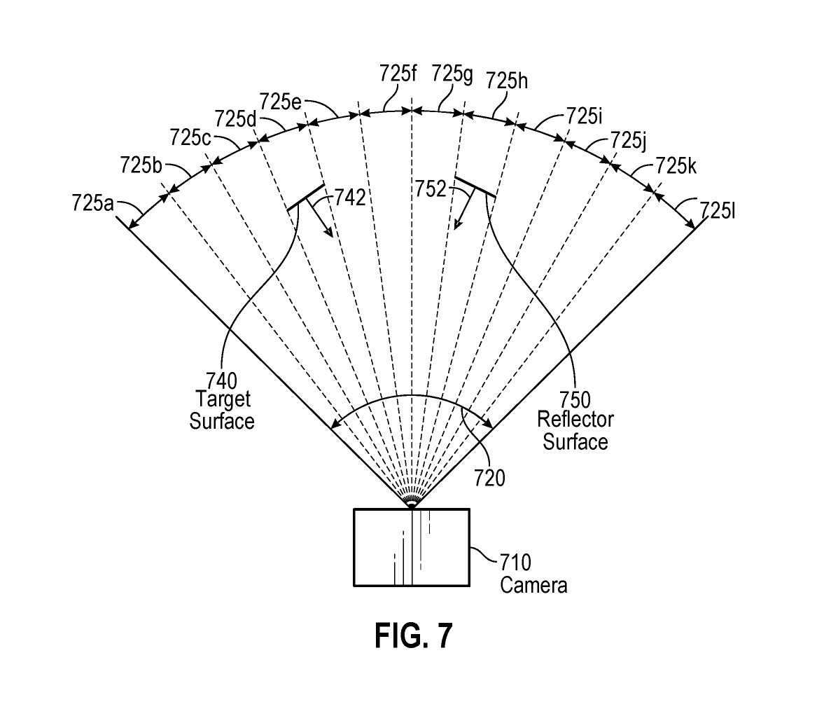

FIG. 7 illustrates an example in which a simulated target surface 740 has been generated and a reflector surface 750 has been selected in a field of view 720 for a frame captured by a time of flight camera 710. The time of flight camera 710 may be implemented using, for example, the time of flight camera 305 illustrated in FIG. 3, and other aspects of system 300 and method 400 may be utilized in connection with FIGS. 7-10. Although FIG. 7 illustrates a two-dimensional view, involving only a single row of target areas (such as, for example, one of the rows 1-9 in the target portion map 520 illustrated in FIG. 5), this is for purposes of simplifying the illustration and its discussion, and it is understood that aspects described for FIG. 7 apply more broadly, such as across the target portions, target surfaces, and reflector surfaces illustrated in FIGS. 5 and 6.

Much as with the target portion map 520 illustrated in FIG. 5, a horizontal field of view 720 of the time of flight camera 710 has been divided into 12 columns of target portions, including target portions 725a, 725b, 725c, 725d, 725e, 725f, 725g, 725h, 725i, 725j, 725k, and 725l. As discussed above, other approaches may be used to identify target portions within a scene, field of view, and/or frame. In FIG. 7, two generated simulated target surfaces are illustrated: a first target surface 740 for target portion 725e and having an orientation indicated by a normal vector 742, and a second target surface (selected as a reflector surface 750) for target portion 725h and having an orientation indicated by normal vector 752. Additionally, the second target surface has been selected as a reflector surface 750.

Referring again to FIG. 4, at 470 the method 400 includes generating a simulated multipath response for the current target surface by simulating a multipath reflection for each of the second reflector surfaces. For example, by simulating, for each reflector surface included in the second plurality of reflector surfaces, a multipath reflection of light emitted by the camera, reflected by the reflector surface to the target surface, and reflected by the target surface to the camera, to generate the simulated multipath response for the target surface. As shown in FIG. 3, the system 300 includes the light transport simulation module 345, which is configured to, for each second plurality of reflector surfaces selected for a target surface (for example, as discussed above for 460 in FIG. 4), simulate, for each reflector surface included in the second plurality of reflector surfaces, a multipath reflection of light emitted by the camera, reflected by the reflector surface to the target surface, and reflected by the target surface to the camera, to generate a simulated multipath response for the target surface. The system 300 is configured to use the light transport simulation module 345 to generate a simulated multipath response for each of the target surfaces generated at 430 and/or by the target surface generator 325.

In some implementations, the light transport simulation performed at 470 and/or by the light transport simulation module 345 includes determining, by simulating transport of light emitted by the time of flight camera (for example, emitted light 210 illustrated in FIG. 2), a ratio (Rᵢⱼ) between (a) a first amount of the emitted light received at the time of flight camera after reflecting along a path from the camera to the reflector surface, from the reflector surface to the target surface, and from the target surface back to the time of flight camera, and (b) a second amount of the emitted light received at the time of flight camera after being reflected from the target surface to the time of flight camera.

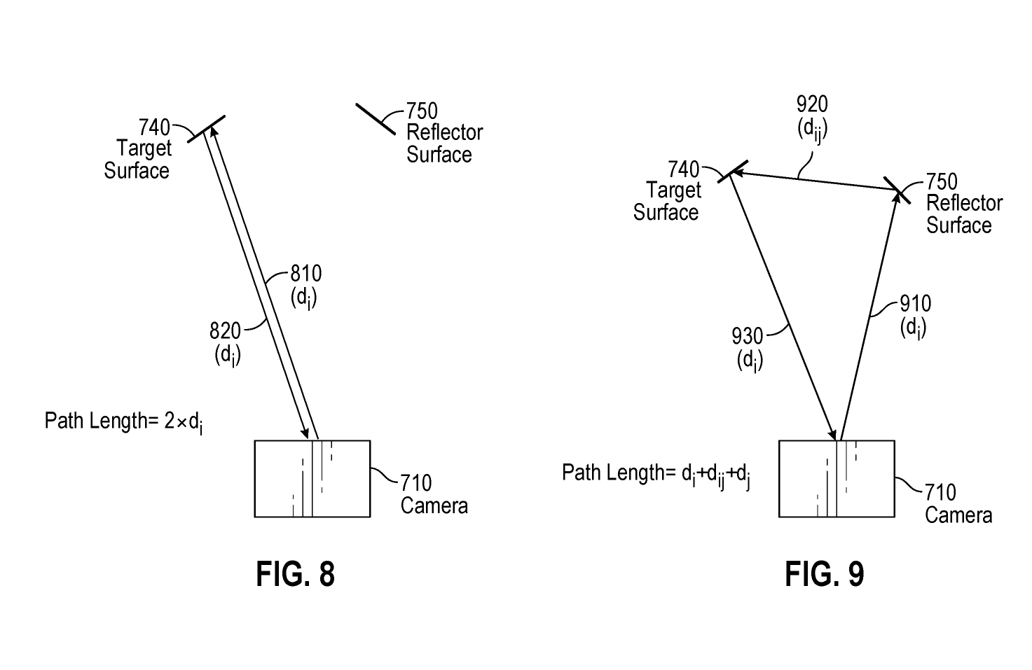

FIG. 8 illustrates an example of simulating an amount of emitted light received at a time of flight camera after being reflected from a target surface to the time of flight camera. The example in FIG. 8 includes the target surface 740, reflector surface 750, and time of flight camera 710 of FIG. 7. In the example in FIG. 8, the simulated amount of light is a simulated direct component of light reflected by the simulated target surface 740 and received at the time of flight camera 710. For the simulation, emitted light travels directly from the time of flight camera 710 to the simulated target surface 740 along a first portion 810 of a direct path between the time of flight camera 710 and the simulated target surface 740. The emitted light is reflected by the simulated target surface 740 directly back to the time of flight camera 710 along a second portion 820 of the direct path, resulting in the first amount of emitted light received at a time of flight camera discussed in the preceding paragraph. The emitted light travels twice the precomputed distance for the target surface (dᵢ), resulting in a path length of 2×di, which affects the first amount of light. The first amount of light may also be reduced based on an orientation of the target surface 740 relative to the time of flight camera 710 and an estimated albedo of the target surface 740.

FIG. 9 illustrates an example of simulating an amount of emitted light received at a time of flight camera after reflecting along a path from the time of flight camera to a reflector surface, from the reflector surface to a target surface, and from the target surface back to the time of flight camera. The example in FIG. 9 includes the target surface 740, reflector surface 750, and time of flight camera 710 of FIGS. 7 and 8. In FIG. 9, the simulated amount of light is a simulated multipath component of light reflected by the simulated target surface 740 and received at the time of flight camera 710 contributed by the reflector surface 750. For the simulation, emitted light travels directly from the time of flight camera 710 to the reflector surface 750 along a first portion 910 (with a corresponding distance di, the precomputed distance for the reflector surface 750) of the illustrated “two bounce” indirect path. The emitted light is reflected by the reflector surface 750 to the simulated target surface 740 along a second portion 920 (with a corresponding distance dᵢⱼ) of the indirect path. This light is then reflected from simulated target surface 740 back to the time of flight camera 710 along a third portion 930 (with a corresponding distance dᵢ; the precomputed distance for the target surface 740) of the indirect path, resulting in the second amount of emitted light received at a time of flight camera discussed above. The emitted light travels a total indirect path length (Dᵢⱼ) of dᵢ+dᵢⱼ+dⱼ. which affects the second amount of light. The first amount of light may also be reduced based on orientations of the target surface 740 and the reflector surface 750 relative to the time of flight camera 710 and each other, and estimated albedos of the target surface 740 and the reflector surface.

The ratio Rᵢⱼ for a target surface i and a reflector surface j may be determined according to the following simulation of the first and second amounts of light discussed above:

$${R}_{ij} = \frac{{B}_{j \to i}}{{B}_{i}} \approx \frac{1}{π} ( \frac{{d}_{i}^{2}}{{n}_{i} \cdot {\hat{x}}_{i}} ) ( \frac{( - {n}_{i} \cdot {\hat{x}}_{ij} ) ( {n}_{j} \cdot {\hat{x}}_{ij} )}{{d}_{ij}^{2}} ) ( \frac{{L}_{j}}{{L}_{i}} {ω}_{j} {ρ}_{j} )$$

where:
xᵢ—precomputed position for the target surface
dᵢ²≡∥xᵢ∥²—squared distance to the target surface
dᵢⱼ²—squared distance between the target surface and the reflector surface
\hat{x}ᵢ≡xᵢ/dᵢ—unit view/light direction to the target surface
\hat{x}ᵢⱼ—unit view/light direction between the target surface and the reflector surface
nᵢ—unit normal vector of the target surface
ρᵢ—estimated albedo of the target surface, 0≤ρᵢ≤1
ωⱼ—solid angle subtended by the reflector surface (which, with the square target surfaces illustrated in FIG. 6, may be constant)
Bᵢ—radiosity of target surface due to direct component
B_{j→i}—radiosity of target surface due to multipath contribution by the reflector surface
Lᵢ—illumination towards the target surface (which, depending on the characteristics of a light source, may vary with angular position)
   Many of the values or other components used in the above simulation are precomputed values already generated by the surface precompute module 335. Where the reflector surface has been subsampled from a group of target surfaces (for example, in FIG. 6, one reflector surface is subsampled from each group of nine target surfaces), the above ratio Rᵢⱼ is also multiplied to account for the area of the target surfaces it replaces (for the example illustrated in FIG. 6, the above ratio Rᵢⱼ would be multiplied by 9). The above simulation is a simplified simulation that assumes Lambertian surfaces. In some implementations, non-Lambertian (or specular) reflections from the reflector surface onto the target could also be simulated, although typically material properties for objects in the captured scene are unavailable for such simulations.

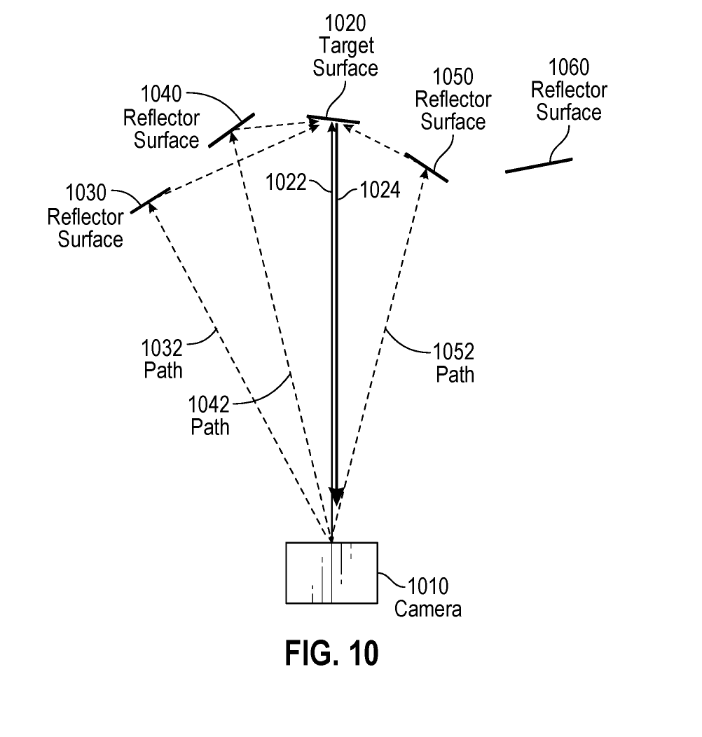

FIG. 10 illustrates an example in which multipath reflections for multiple reflector surfaces are simulated for a single target surface. Time of flight camera 1010 operates much as described for the time of flight camera 305 illustrated in FIG. 3 and/or the time of flight camera 710 illustrated in FIGS. 7-9. As with FIG. 7, although FIG. 10 illustrates a two-dimensional view, aspects described for FIG. 10 apply more broadly. In the example illustrated in FIG. 10, there is a first plurality of four reflector surfaces 1030, 1040, 1050, and 1060. However, because the reflector surface 1060 and the target surface 1020 are not facing each other, it is excluded from a second plurality of three reflector surfaces 1030, 1040, and 1050 for generating a simulated multipath response for the current target surface. Much as described above for determining a first ratio Rᵢⱼ, respective ratios Rᵢⱼ for each reflector and corresponding path distances for indirect paths 1032, 1042, and 1052 may be generated for a simulated multipath response for the target surface 1020. In some implementations, the ratios Rᵢⱼ for the target surface 1020 may be adjusted to represent them instead as ratios of a total reflected light 1024, including the simulated direct component and the simulated indirect components for target surface 1020, by multiplying each ratio Rij with:

$$\frac{1}{1 + {\sum }_{j = 0}^{n} {R}_{ij}}$$

By similarly determining ratios Rᵢⱼ for all of the second plurality of reflector surface for the current surface, the light transport simulation module 345 generates a simulated multipath response for the current target surface (which may include, for example, a respective ratio Rᵢⱼ and an indirect path distance Dᵢⱼ for each of the second plurality of reflector surfaces).

Referring back now to FIG. 4, at 480 the method 400 also includes generating a depth measurement correction for the current target surface based on the simulated multipath response for the current target surface. Referring again to FIG. 3, it can be seen that the system 300 includes a distance correction generation module 350 arranged to obtain the simulated multipath response for the current target surface generated by the light transport simulation module 345 and generate a depth measurement correction for the current target surface.

A generalized multi-reflector multipath model, for “two bounce” multipath, is:

$${M}_{i} = S ( {d}_{i}^{′} ) + {\sum }_{j = 0}^{n} {R}_{ij} S ( {D}_{ij}^{′} / 2 )$$

where:
S(d)—normalized imaging measurement response corresponding to depth d.
dᵢ—Precomputed distance/depth for the target surface.
d′ᵢ—Real (unknown) depth/distance for the target surface.
Dᵢⱼ—Total indirect path distance for multipath reflection based on precomputed distances and/or precomputed positions (dᵢdᵢⱼ+dⱼ).
D′ᵢⱼ—Total real indirect path distance for multipath reflection (d′ᵢ+d′ᵢⱼ+d′ⱼ).
Mᵢ—Multipath infected response from the target surface.

The goal is to find S(d′ᵢ). By using S(dᵢ) as a proxy for Mᵢ, and S(Dᵢⱼ/2) as a proxy for S(D′ᵢⱼ/2), the above model may be rearranged as follows:

$$S ( {d}_{i}^{′} ) = S ( {d}_{i} ) - {\sum }_{j = 0}^{n} {R}_{ij} S ( {D}_{ij} / 2 )$$

This may be further rearranged to arrive at a depth correction Cᵢ for the current target surface:

$${C}_{i} = {d}_{i} - Depth\_Estimate ( S ( {d}_{i} ) - {\sum }_{j = 0}^{n} {R}_{ij} S ( {D}_{ij} / 2 ) )$$

The distance correction generation module 350 may apply this formula to, for each of the second plurality of reflector surfaces, determine a multipath normalized imaging measurement response. The measurement response will correspond to light emitted by the time of flight camera 305 and received by the time of flight camera 305 after travelling a total distance of the indirect path for a reflector surface (normalized imaging measurement response S(Dᵢⱼ/2)). The distance correction generation module 350 may then determine a multipath response contribution for the reflector surface by scaling this multipath normalized imaging measurement response by the ratio Rᵢⱼ for the reflector surface. A total amount of the multipath response contributions determined for all of the second plurality of reflector surfaces may then be removed from an initial normalized imaging response S(dᵢ) to generate a simulated imaging measurement response S(d′ᵢ) (which may no longer be normalized after the subtractions) that has been corrected for the multipath response contributions for the simulated reflector surfaces. The distance correction generation module 350 may obtain a depth estimate (Depth_Estimate) from the distance calculation module 355, and subtract the obtained depth estimate from the original precomputed distance dᵢ for the target surface to generate a depth correction Cᵢ for the target surface and its corresponding target portion.

The normalized imaging measurement response S(d) provides an idealized imaging measurement response, such as the imaging measurement responses discussed in connection with FIG. 2, for emitted light that has traveled a total distance (such as a path length) 2×d and that does not include an ambient lighting component, that has been normalized. For example, an imaging measurement response provided as a multi-dimensional vector may be scaled to a unit vector. As a result, magnitudes of components of a normalized imaging response are not representative of reductions in light intensity in proportion to the square of the path length. The distance correction generation module 350 may obtain a normalized imaging measurement response S(d) from the distance calculation module 355. Even for an idealized example, such as a surface that only returns a direct reflection (the reflected light has no multipath component), the surface directly facing the time of flight camera, the surface reflecting all of its received emitted light (having an albedo of 1), and an environment without ambient lighting, there can be a complex relationship (which may also vary across pixels) between a distance d and its normalized imaging measurement response S(d). For example, in an implementation utilizing light integration periods to accumulate and measure charges, as discussed in connection with FIG. 2, the resulting charges for a given path length may be a result of, among other things, a convolution of a waveform for the emitted light (which typically is not ideal, and may vary with angle), the time delay for the path length (which affects a portion or portions of the reflected waveform coinciding with various accumulation periods), non-ideal switching characteristics at the beginning and end of an accumulation period, and/or non-ideal photodetector responsiveness. In some implementations, the distance calculation module 355 may utilize lookup tables and interpolation to generate a normalized imaging measurement response. In some implementations, the relationship between a distance d and its normalized imaging measurement response S(d) can be specific to an individual time of flight camera or device including the camera, with S(d) determined based on a camera-specific and/or device-specific calibration.

The techniques described above involving determining ratios Rᵢⱼ for each of the second plurality of reflector surfaces for a target surface, and scaling of normalized imaging measurement responses for indirect path lengths Dᵢⱼ by the determined ratios Rᵢⱼ offers significant reductions in computational complexity. Whereas conventional techniques involving physics-based simulation of multipath expend computational time and energy in ensuring that simulated values are consistent with the actual depth imaging measurements, the techniques in this disclosure achieve effective and useful estimates of multipath interference by leveraging simpler simulations of relative radiosities for multipath reflections (which, for example, can ignore many details of camera response characteristics) and using them in combination with normalized imaging measurement responses (for indirect path lengths Dᵢⱼ and distance dᵢ) that incorporate and/or reflect actual response characteristics of the time of flight camera 305.

Also, by only simulating “two bounce” multipath reflections, an effective tradeoff is made for achieving realtime performance. In general, multipath contributions are greatest for “two bounce” multipath reflections, with diminishing returns (in terms of improved depth estimates) obtained by simulating multipath reflections involving more than two reflecting surfaces.

Referring again to FIG. 4, after generating a depth measurement correction for a current target surface at 480, if any additional target surfaces remain, the method 400 returns to 460 for the next target surface; otherwise, the method 400 proceeds to 490. Much as discussed previously, method 400 or other aspects of this disclosure are not intended to imply only iterative processing of the target surfaces. In particular, the processing done in connection with 470 is highly parallelizable, and may be performed by multiple processing devices in order to realize realtime performance and use greater numbers of target surfaces and/or reflector surfaces to achieve improved fidelity. Additionally, aspects of the processing done in connection with 480 are also parallelizable.

At 490, the method 400 determines distances for the pixels associated with the depth imaging measurements received at 410 based on the depth measurement corrections generated for the target surfaces at 480. As shown in FIG. 3, the system 300 includes the distance calculation module 355 which, in addition to other features described above, is further arranged to determine distances for the pixels for the frame being processed based on the depth measurement corrections generated by the distance correction generation module 350 for the target surfaces. The depth measurement corrections and positions of their corresponding target surfaces or target portions may be used to define a low-resolution correction field. For each of the pixels, a depth measurement correction may be interpolated (using, for example, bilinear interpolation) from the low-resolution correction field. In some implementations, edge-aware bilateral interpolation may be used to improve application of the low-resolution correction field to the higher resolution pixels. As a result, the processing at 490 or by the distance calculation module 355 provides a depth image (which may be stored in, for example, the frame buffer 310, including an in-place correction of the depth imaging measurements originally stored in the frame buffer 310) at the full original resolution of the time of flight camera 305 that has been corrected for multipath interference.

The described simulations using a reduced number of target surfaces for light transport simulation and interpolation of a resulting low-resolution correction field for correcting multipath interference at the higher resolution of the pixels allows use of physics-based light transport simulation techniques that generally have been inaccessible for high resolution realtime applications.

Furthermore, in some implementations, the system 300 can include a postprocessing measurement correction module 360 configured to perform additional operations on the multipath-corrected result. For example, the postprocessing measurement correction module 360 may correct for optical distortion or perform edge detection.

Much as discussed in connection with FIG. 1, the time of flight camera 305 is configured to capture and provide depth imaging measurements for successive frames at a frame rate. In an implementation of the system 300 adapted to realize realtime correction of multipath interference, as discussed above, for frames received at a frame rate of up to 10 fps, the system 300 is arranged to complete determining distances for a frame of pixels corrected for multipath interference within 100 milliseconds of the depth imaging measurements for the pixels being received by the frame buffer 310 for the frame. For a frame rate of up to 20 fps, the 100 milliseconds is reduced to be within 50 milliseconds. For a frame rate of up to 30 fps, the 100 milliseconds is reduced to be within 32 milliseconds. For a frame rate of up to 60 fps, the 100 milliseconds is reduced to be within 16 milliseconds.

In some implementations, the system 300 is arranged to complete determining distances for a frame of pixels corrected for multipath interference in less than half a time before depth imaging measurements for a next frame is received; in one example, with frames including approximately 100,000 pixels received at a frame rate of approximately 5 fps the system 300 is arranged to complete determining distances for each frame of pixels corrected for multipath interference within 50 milliseconds of receipt of depth imaging measurements for a frame. This allows processing resources used for the multipath interference correction to be used for other processing tasks, including, for example, depth image processing or feature recognition, between receiving successive frames of pixels.

In some other implementations, the system 300 illustrated in FIG. 3 is a mobile device, and the time of flight camera 305 may be integrated into the mobile device, or be communicatively coupled to, but not integrated into, the mobile device. As discussed above, various aspects of the disclosed techniques are effective, for respective reasons, in reducing computational effort. For a mobile device, power consumption and/or heat generated for such computations is a particularly significant concern, and various aspects of the above techniques are effective in addressing such concerns while achieving realtime, high quality results.

In some implementations, the system illustrated in FIG. 3 is a virtual reality (VR), augmented reality (AR), or mixed reality (MR) device. Although such devices also, in general, enjoy many of the benefits discussed above for mobile devices, there are additional benefits obtained by various aspects of the disclosed techniques for such devices, due to the immersive realtime user experience in conjunction with related depth sensing applications such as, but not limited to, gesture recognition and scene feature registration and/or recognition. In particular, due to the scene being directly visible through a mixed reality device, achieving effective realtime correction of multipath interference can significantly improve realtime registration of “holographic” visual elements with respective portions of the scene, thereby improving the user experience.

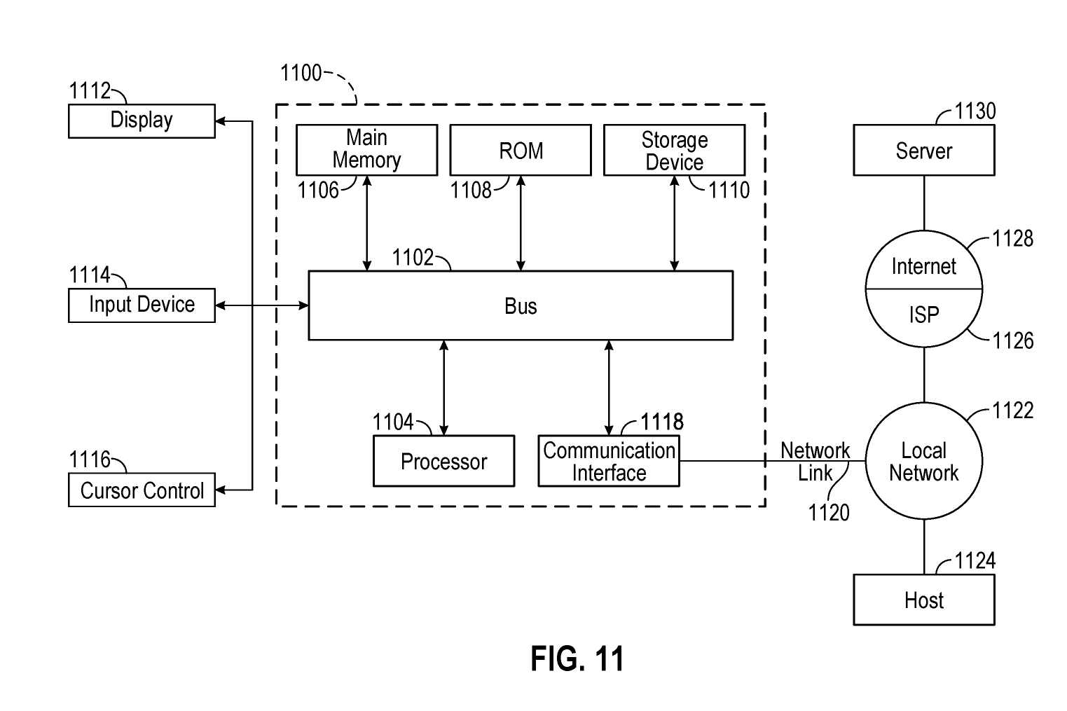

FIG. 11 illustrates a block diagram showing a computer system 1100 upon which aspects of this disclosure may be implemented. Computer system 1100 includes a bus 1102 or other communication mechanism for communicating information, and a processor 1104 coupled with bus 1102 for processing information. Computer system 1100 also includes a main memory 1106, such as a random access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104.

The computer system 1100 can implement, for example, one or more of, or portions of the modules and other component blocks included in the system 300 illustrated in FIG. 3. Examples can include, but are not limited to, time of flight camera 305, frame buffer 310, measurement preprocessing module 315, target portion identifier 320, target surface generator 325, reflector selection module 330, surface precompute module 335, working memory 340, light transport simulation module 345, distance correction generation module 350, distance calculation module 355, and/or postprocessing measurement correction module 360.

The computer system 1100 can also implement, for example, one or more of, or portions of the operations illustrated in FIG. 4. Examples can include, but are not limited to, operations at 410 of receiving depth imaging measurements for pixels for a frame captured by time of flight camera 305 into main memory 1106, or into a buffer (not visible in FIG. 11) coupled to bus 1102 and corresponding to the frame buffer 310 illustrated in FIG. 3. Other examples can include, through processor 1104 executing instructions stored in main memory 1106, operations at 420 of identifying target operations of scenes in the frame captured at 410, and operations at 430 of simulating target surfaces for each of the target portions identified at 420. The computer system 1100 illustrated in FIG. 11 can similarly implement one or more of, or respective portions of, the above-described operations 450, 460, 470, 480, and/or 490 of FIG. 4.

Computer system 1100 can further include a read only memory (ROM) 1108 or other static storage device coupled to bus 1102 for storing static information and instructions for processor 1104. A storage device 1110, such as a flash or other non-volatile memory can be coupled to bus 1102 for storing information and instructions.

Computer system 1100 may be coupled via bus 1102 to a display 1112, such as a liquid crystal display (LCD), for displaying information, for example, associated with the FIG. 3 time of flight camera 305 or the FIG. 10 time of flight camera 1010. One or more user input devices, such as the example user input device 1114 can be coupled to bus 1102, and can be configured for receiving various user inputs, such as user command selections and communicating these to processor 1104, or to a main memoir 1106. The user input device 1114 can include physical structure, or virtual implementation, or both, providing user input modes or options, for controlling, for example, a cursor, visible to a user through display 1112 or through other techniques, and such modes or operations can include, for example virtual mouse, trackball, or cursor direction keys.

The computer system 1100 can include respective resources of processor 1104 executing, in an overlapping or interleaved manner, multiple module-related instruction sets to provide a plurality of the modules illustrated in FIG. 3. For example, referring to FIGS. 3 and 11, preprocessing measurement correction module 315, distance correction generation module 350, and other modules can be implemented as respective resources of the processor 1104 executing respective module instructions. Instructions may be read into main memory 1106 from another machine-readable medium, such as storage device 1110.

In some examples, hard-wired circuitry may be used in place of or in combination with software instructions to implement one or more of the modules illustrated in FIG. 3, or to perform one or more portions of the operations illustrated in FIG. 4, or both.

The term “machine-readable medium” as used herein refers to any medium that participates in providing data that causes a machine to operate in a specific fashion. Such a medium may take forms, including but not limited to, non-volatile media, volatile media, and transmission media. Non-volatile media can include, for example, optical or magnetic disks, such as storage device 1110. Transmission media can include optical paths, or electrical or acoustic signal propagation paths, and can include acoustic or light waves, such as those generated during radio-wave and infra-red data communications, that are capable of carrying instructions detectable by a physical mechanism for input to a machine.

Computer system 1100 can also include a communication interface 1118 coupled to bus 1102, for two-way data communication coupling to a network link 1120 connected to a local network 1122. Network link 1120 can provide data communication through one or more networks to other data devices. For example, network link 1120 may provide a connection through local network 1122 to a host computer 1124 or to data equipment operated by an Internet Service Provider (ISP) 1126 to access through the Internet 1128 a server 1130, for example, to obtain code for an application program.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus the following claims are hereby incorporated into the Detailed Description, with each claim standing on its own as a separately claimed subject matter.

What is claimed is:

1. A system for determining distances to features in a scene, the system comprising:
a frame buffer arranged to receive, for a frame captured by a time of flight camera, depth imaging measurements for each of a plurality of pixels arranged to measure light received from respective portions of the scene;
a target portion identifier module configured to identify a plurality of target portions of the scene, each target portion corresponding to portions of the scene measured by two or more of the pixels;
a target surface generator configured to simulate a plurality of target surfaces, including determining, for each target portion included in the plurality of target portions, a position and an orientation for a respective simulated target surface based on the depth imaging measurements for the measured portions of the scene included in the target portion;
a reflector selection module configured to select one half or fewer of the plurality of target surfaces as a first plurality of reflector surfaces and, for each target surface included in the plurality of target surfaces, select a second plurality of reflector surfaces from the first plurality of reflector surfaces;
a light transport simulation module configured to, for each target surface included in the target surfaces, simulate, for each reflector surface selected by the reflector selection module for the target surface, a multipath reflection of light emitted by the camera, reflected by the reflector surface to the target surface, and reflected by the target surface to the camera, to generate a simulated multipath response for the target surface;
a depth measurement correction generation module configured to generate a depth measurement correction for each target surface based on the simulated multipath response generated for the target surface by the light transport simulation module; and
a distance calculation module configured to determine distances for the pixels based on the depth measurement corrections generated by the depth measurement correction generation module for the plurality of target surfaces.

2. The system according to claim 1, wherein to simulate the multipath reflection, the light transport simulation module is further configured to:
for each reflector surface selected by the reflector selection module for a target surface:
determine a simulated ratio between (a) an amount of the emitted light received at the camera after reflecting along a path from the camera to the reflector surface, from the reflector surface to the target surface, and from the target surface to the camera, and (b) an amount of the emitted light received at the camera after being reflected from the target surface to the camera,
determine a multipath normalized imaging measurement response corresponding to light emitted by the camera and received by the camera after travelling a total distance of the path, and
determine a multipath response contribution for the reflector surface by scaling the multipath normalized imaging measurement response by the ratio.

3. The system according to claim 2, wherein the amount of the emitted light received at the camera after being reflected from the target surface to the camera is a direct component of the emitted light reflected by the target surface.

4. The system according to claim 2, wherein to generate the depth measurement correction for each target surface, the depth measurement correction generation module is further configured to generate the depth measurement correction based on a total of the multipath response contributions determined for the reflector surfaces selected by the reflector selection module for the target surface.

5. The system according to claim 2, wherein the multipath normalized imaging measurement responses are multi-dimensional vectors with components generated based on amounts of reflected light measured during a plurality of light integrations used by the camera to capture the frame.

6. The system according to claim 1, wherein the distance calculation module is further configured to define a low-resolution correction field based on the depth measurement corrections generated by the depth measurement correction generation module for the plurality of target surfaces, and determine the distances for the pixels based on interpolated depth measurement corrections generated from the low-resolution correction field.

7. A mobile device comprising the system according to claim 1.

8. The system according to claim 1, further including the time of flight camera.

9. A mixed reality device comprising the system according to claim 8.

10. A method of determining distances to features in a scene, the method comprising:
receiving, for a frame captured by a time of flight camera, depth imaging measurements for each of a plurality of pixels arranged to measure light received from respective portions of the scene;
identifying a plurality of target portions of the scene, each target portion corresponding to portions of the scene measured by two or more of the pixels;
simulating a plurality of target surfaces, including determining, for each target portion included in the plurality of target portions, a position and an orientation for a respective simulated target surface based on the depth imaging measurements for the measured portions of the scene included in the target portion;
selecting one half or fewer of the plurality of target surfaces as a first plurality of reflector surfaces;
for each target surface included in the plurality of target surfaces,
selecting a second plurality of reflector surfaces for the target surface from the first plurality of reflector surfaces,
simulating, for each reflector surface included in the second plurality of reflector surfaces selected for the target surface, a multipath reflection of light emitted by the camera, reflected by the reflector surface to the target surface, and reflected by the target surface to the camera, to generate a simulated multipath response for the target surface, and
generating a depth measurement correction for the target surface based on the simulated multipath response generated for the target surface; and
determining distances for the pixels based on the depth measurement corrections generated for the plurality of target surfaces.

11. The method according to claim 10, wherein:
the simulating to generate the simulated multipath response for the target surface includes performing, for each reflector surface in the second plurality of reflector surfaces selected for the target surface:
determining a simulated ratio between (a) an amount of the emitted light received at the camera after reflecting along a path from the camera to the reflector surface, from the reflector surface to the target surface, and from the target surface to the camera, and (b) an amount of the emitted light received at the camera after being reflected from the target surface to the camera,
determining a multipath normalized imaging measurement response corresponding to light emitted by the camera and received by the camera after travelling a total distance of the path, and
determining a multipath response contribution for the reflector surface by scaling the multipath normalized imaging measurement response by the ratio.

12. The method according to claim 11, wherein the amount of the emitted light received at the camera after being reflected from the target surface to the camera is a direct component of the emitted light reflected by the target surface.

13. The method according to claim 11, wherein the generating the depth measurement correction for the target surface includes generating the depth measurement correction based on a total of the multipath response contributions determined for the second plurality of reflector surfaces selected for the target surface.

14. The method according to claim 11, wherein the multipath normalized imaging measurement responses are multi-dimensional vectors with components generated based on amounts of reflected light measured during a plurality of light integrations used by the camera to capture the frame.

15. The method according to claim 10, further comprising defining a low-resolution correction field based on the depth measurement corrections generated for the plurality of target surfaces, wherein the determining the distances for the pixels includes generating interpolated depth measurement corrections from the low-resolution correction field.

16. The method according to claim 10, wherein the determining distances for the pixels based on the depth measurement corrections is completed within 50 milliseconds of the receiving the depth imaging measurements.

17. The method according to claim 16, wherein the plurality of pixels includes at least 100,000 pixels.
